(19) United States
(12) Patent Application Publication
(10) Pub. No.: US 2026/0281124 A1
(43) Pub. Date: Sep. 17, 2026

(54) DATA COMMUNICATION METHOD AND APPARATUS, ELECTRONIC DEVICE, AND STORAGE MEDIUM

(71) Applicant: Beijing Volcano Engine Technology Co., Ltd., Beijing (CN)

(72) Inventors: Peixuan HE, Beijing (CN); Yong SUN, Beijing (CN); Dian CHEN, Beijing (CN); Yao ZHANG, Beijing (CN); Ye WU, Beijing (CN); Bofeng WU, Beijing (CN)

(21) Appl. No.: 19/425,924

(22) Filed: Dec. 18, 2025

(30) Foreign Application Priority Data
Mar. 14, 2025 (CN) 202510304597.7

(51) Int. Cl. H04L 9/40

(52) U.S. Cl. CPC H04L 63/123; H04L 63/0435

(57) ABSTRACT

A data communication method and apparatus, an electronic device and a storage medium are provided. The method includes: sending, to a requester, attestation information and a first key for a first service in response to receiving, from the requester, a verification request for the first service, the first key being determined based on a relationship between the requester and the first service; receiving, from the requester, a processing request for the first service, the processing request including encrypted first data; obtaining, using a second key related to the first key, decrypted first data from the processing request; and sending, to the requester, a processing result of the first data in response to the processing request.

### CROSS-REFERENCE TO RELATED APPLICATION

The present application claims priority to Chinese Patent Application No. 202510304597.7, filed on Mar. 14, 2025, which is incorporated herein by reference in its entirety as a part of the present application.

### TECHNICAL FIELD

Exemplary embodiments of the present disclosure generally relate to the field of computers, and particularly to a data communication method and apparatus, an electronic device, and a computer-readable storage medium.

### BACKGROUND

With an increasing demand for large-scale computing, the structure of computing services has become more and more complex. Multi-node, clustered distributed service architectures have gradually become the standard configuration for computing service scenarios. In this context, how to ensure the data communication security of clustered services is an urgent issue that needs to be solved.

### SUMMARY

In a first aspect of the present disclosure, a data communication method is provided. The method includes: sending, to a requester, attestation information and a first key for a first service, in response to receiving, from the requester, a verification request for the first service, the first key being determined based on a relationship between the requester and the first service; receiving, from the requester, a processing request for the first service, the processing request including encrypted first data; obtaining, using a second key related to the first key, decrypted first data from the processing request; and sending, to the requester, a processing result of the first data in response to the processing request.

In a second aspect of the present disclosure, a data communication method is provided. The method includes: sending, to a first service, a verification request for the first service; receiving, from the first service, attestation information and a first key for the first service; sending, to the first service, a processing request including encrypted first data in response to the attestation information indicating that an execution environment of the first service is trusted; and receiving, from the first service, a processing result of the first data.

In a third aspect of the present disclosure, a data communication apparatus is provided. The apparatus includes: a first sending module, configured to send, to a requester, attestation information and a first key for a first service in response to receiving, from the requester, a verification request for the first service, the first key being determined based on a relationship between the requester and the first service; a receiving module, configured to receive, from the requester, a processing request for the first service, the processing request including encrypted first data; a processing module, configured to obtain, using a second key related to the first key, decrypted first data from the processing request; and a second sending module, configured to send, to the requester, a processing result of the first data in response to the processing request.

In a fourth aspect of the present disclosure, a data communication apparatus is provided. The apparatus includes: a first sending module, configured to send, to a first service, a verification request for the first service; a first receiving module, configured to receive, from the first service, attestation information and a first key for the first service; a second sending module, configured to send, to the first service, a processing request including encrypted first data in response to the attestation information indicating that an execution environment of the first service is trusted; and a second receiving module, configured to receive, from the first service, a processing result of the first data.

In a fifth aspect of the present disclosure, an electronic device is provided. The device includes at least one processor; and at least one memory, where the at least one memory is coupled to the at least one processor and stores instructions executable by the at least one processor, and the instructions, when executed by the at least one processor, cause the device to perform the method of the first aspect or the second aspect.

In a sixth aspect of the present disclosure, a computer-readable storage medium is provided. The computer-readable storage medium stores a computer program executable by a processor to implement the method of the first aspect or the second aspect.

In a seventh aspect of the present disclosure, a computer program product is provided. The computer program product is tangibly stored in a computer storage medium and includes computer-executable instructions, where the computer-executable instructions, when executed by a device, cause the device to perform the method of the first aspect or the second aspect.

It would be appreciated that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1 shows a schematic diagram of an exemplary environment in which the embodiments of the present disclosure can be implemented;

FIG. 2 shows a schematic diagram of a data communication process according to some embodiments of the present disclosure;

FIG. 3 shows a schematic diagram of an exemplary process of data communication in a scenario according to some embodiments of the present disclosure;

FIG. 4 shows a schematic diagram of an exemplary process of data communication in another scenario according to some embodiments of the present disclosure;

FIG. 5 shows a schematic diagram of an exemplary process of data communication in yet another scenario according to some embodiments of the present disclosure;

FIG. 6 shows a flowchart of a data communication process applied to a first service according to some embodiments of the present disclosure;

FIG. 7 shows a flowchart of a data communication process applied to a requester of data communication according to some embodiments of the present disclosure;

FIG. 8 shows a block diagram of an exemplary data communication apparatus applied to a first service according to some embodiments of the present disclosure;

FIG. 9 shows a block diagram of an exemplary data communication apparatus applied to a requester of data communication according to some embodiments of the present disclosure; and

FIG. 10 shows a block diagram of an electronic device capable of implementing multiple embodiments of the present disclosure.

### DETAILED DESCRIPTION

The embodiments of the present disclosure will be described in more detail below with reference to the drawings. Although certain embodiments of the present disclosure are shown in the drawings, it would be appreciated that the present disclosure may be implemented in various forms and should not be construed as being limited to the embodiments set forth herein; rather, these embodiments are provided for a more thorough and complete understanding of the present disclosure. It would be appreciated that the drawings and embodiments of the present disclosure are only for illustrative purposes and are not intended to limit the protection scope of the present disclosure.

It would be noted that the titles of any section/subsection provided herein are not restrictive. Various embodiments are described throughout the present disclosure, and any type of embodiments may be included under any section/subsection. In addition, the embodiments described in any section/subsection may be combined with any other embodiments described in the same section/subsection and/or different section/subsection in any manner.

In the description of the embodiments of the present disclosure, the term "include/comprise" and similar terms thereof should be construed as open-ended inclusions, that is, "include/comprise but not limited to". The term "based on" should be construed as "at least partially based on". The term "an embodiment" or "the embodiment" should be construed as "at least one embodiment". The term "some embodiments" should be construed as "at least some embodiments". Other definitions, both explicit and implicit, may be included below. The terms "first", "second", etc. may refer to different or same objects. Other definitions, both explicit and implicit, may be included below.

The embodiments of the present disclosure may involve user data, data acquisition and/or data use, etc. These aspects are in accordance with corresponding laws, regulations and related provisions. In the embodiments of the present disclosure, all data collection, acquisition, handling, processing, forwarding and use, etc. are performed on the premise that the user is aware of and confirms. Accordingly, when implementing the embodiments of the present disclosure, the user should be informed of and authorize the type, range of use, use scenarios, etc., of data or information that may be involved in an appropriate manner in accordance with relevant laws and regulations. The specific manner of informing and/or authorizing may vary according to actual situations and application scenarios, and the scope of the present disclosure is not limited in this regard.

The solutions in this specification and embodiments, if involving personal information processing, will be processed on the premise that there is a legal basis (for example, the consent of the subject of the personal information is obtained, or when it is necessary for the performance of a contract, etc.), and will only be processed within the scope of provisions or agreements. If the user refuses to process personal information other than the necessary information required for the basic functions, it will not affect the user's use of the basic functions.

### Exemplary Environment

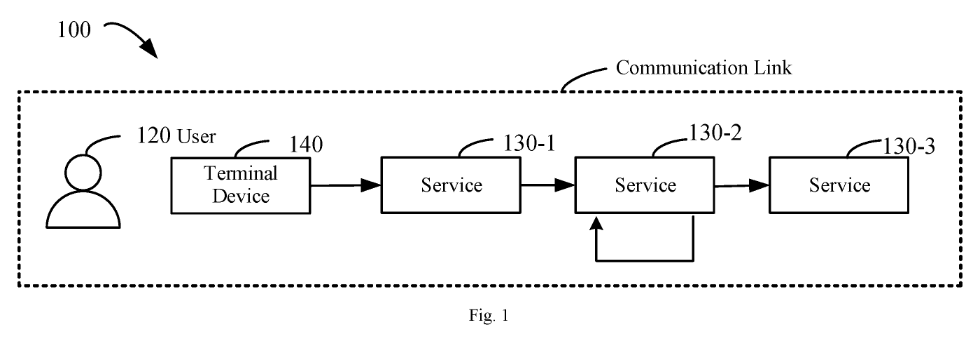

FIG. 1 shows a schematic diagram of an exemplary environment 100 in which the embodiments of the present disclosure can be implemented. As shown in FIG. 1, the exemplary environment 100 may include a user 120, a terminal device 140 associated with the user 120, a service 130-1, a service 130-2, a service 130-3, and the like. The service 130-1, the service 130-2 and the service 130-3 may also be referred to individually or collectively as a service 130. The user 120 may interact with an application installed or running on the terminal device 140. The process of the user 120 using the application involves invoking a series of services 130 to implement his/her own requests. That is, a communication link may be used to implement the requests of the user 120.

The service 130 may be implemented by a trusted execution environment (TEE). The TEE is a secure area within a central processing unit (CPU). The TEE runs in an isolated environment and in parallel with an operating system. The central processing unit may ensure that the confidentiality and integrity of the code and data in the TEE are protected. The TEE may use hardware and software to protect the code and data, and is more secure than the operating system. A trusted application running in the TEE may access all the functions of the device's main processor and memory, while the hardware isolation protects these components from user-installed applications running in the main operating system. The TEE may have different implementation schemes on different types of central processing units. The embodiments of the present disclosure are not limited in this regard.

When the TEE is used to implement the service 130, the service 130 may also be referred to as a confidential service. The confidential service may ensure the confidentiality of the data processing flow. The confidential service may be verified by measurement or other means to ensure that the service running in the TEE is an expected service.

The terminal device 140 associated with the user 120 may perform data communication with the confidential service running in the same TEE. In addition, data communication may also be performed between different confidential services (for example, between the service 130-1 and the service 130-2), and between different processing units within a confidential service (for example, the service 130-2).

It would be appreciated that the structure and function of each element in the environment 100 are described for exemplary purposes only, without suggesting any limitation to the scope of the present disclosure.

At present, there have been some solutions to the secure communication of clustered confidential services. These solutions include a trust flow solution, a solution based on private cloud compute (PCC), and a solution based on remote attestation transport layer security (RA-TLS). However, all the above three solutions have certain drawbacks. The trust flow solution may only implement users' access to service nodes, but fails to implement secure communication in a clustered scenario. The PCC-based solution is poorly scalable and only supports one application. The RA-TLS-based solution supports encryption at the transport layer but fails to implement encryption at the application layer, and currently does not support establishing communication connections between different types of TEE nodes. As a result, the existing confidential service data communication solutions are poor in security and/or compatibility with different scenarios.

The embodiments of the present disclosure provide a solution to data communication. In this solution, a first service sends, to a requester, attestation information and a first key for the first service in response to receiving, from the requester, a verification request for the first service, the first key being determined based on a relationship between the requester and the first service; receives, from the requester, a processing request for the first service, the processing request including encrypted first data; obtains, using a second key related to the first key, decrypted first data from the processing request; and sends, to the requester, a processing result of the first data in response to the processing request.

In this way, according to the embodiments of the present disclosure, it’s able to use different keys to encrypt data communication according to different relationships between the requester and the service provider. That is, an appropriate key may be selected according to a scenario to implement secure communication. This not only expands the communication scenarios of clustered confidential services, but also improves the security and efficiency of data communication in various scenarios of clustered confidential services. In this way, the user's expectation of secure and efficient data transmission with a computing cluster may be fulfilled.

Various exemplary implementations of the solution are further described below in detail with reference to the drawings.

### Exemplary Architecture

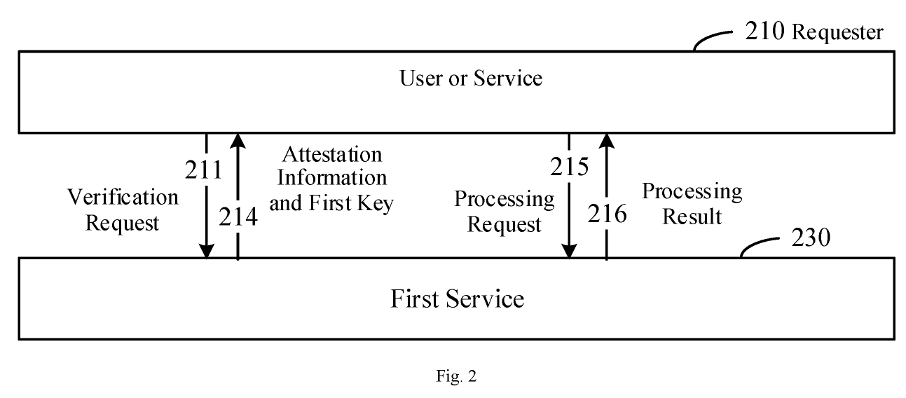

FIG. 2 shows a schematic diagram of a data communication process according to some embodiments of the present disclosure. The data communication process may be implemented in a TEE. The requester 210 may perform data communication with a service (the first service 230 in this example) on behalf of the user 120 through the terminal device 140 shown in FIG. 1. The requester 210 may be any other service in the cluster different from the first service 230. The requester 210 may be located inside the first service 230. The data communication process shown in FIG. 2 is described below with reference to FIG. 1.

In this example, the requester 210 requests the first service 230 to perform data processing. At 211, the requester 210 sends a verification request to the first service 230. After receiving the verification request, the first service 230 obtains attestation information for the first service 230 at least from an attestation provision service (EPS) associated with the first service 230. The attestation information includes at least one of an attestation report or an attestation result. The attestation report may indicate the trustworthiness of the execution environment of the first service 230. For example, the attestation report may indicate whether the first service 230 and the requester 210 are in the same TEE. The attestation result may include a verification result of the attestation report.

Exemplarily, the first service 230 and the EPS may be implemented on a virtualized instance (for example, a virtual machine) of the cluster. The EPS may communicate with multiple processing units in the first service 230, respectively, and generate an attestation report according to the access request of each processing unit. The access request of each processing unit may be triggered after the processing unit receives the verification request from the requester 210. In some embodiments, after generating the attestation report, the EPS may send the attestation report to a remote attestation service (RAS). The RAS may verify the validity of the attestation report sent by the EPS to obtain an attestation result, and may return the attestation result to the EPS. In the embodiments of the present disclosure, a "processing unit" may refer to a processing resource of any appropriate granularity for implementing at least a part of the functions of the service. As an example, the processing unit may be a container set, which includes one or more containers. For example, the processing unit may be a pod.

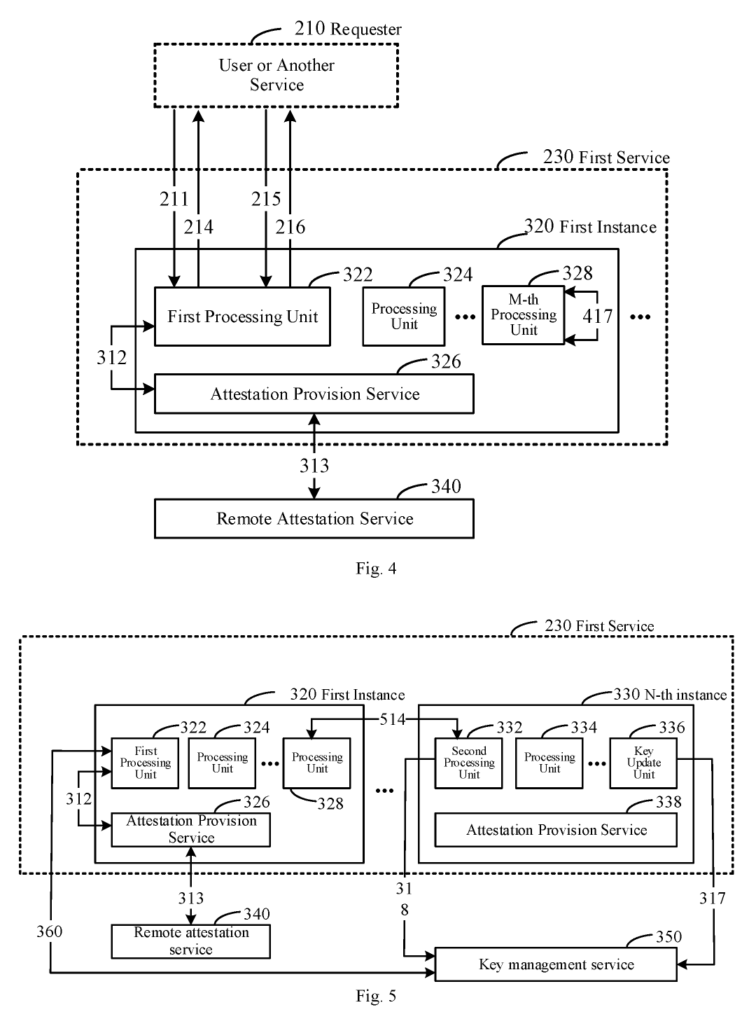

The first service 230 may determine a first key according to the relationship between the requester 210 and the first service 230. In some embodiments, the first key may be a shared public key between different processing units of the first service 230. For example, in a scenario where the requester 210 is located outside the first service 230 and different requests sent by the requester 210 are received by different processing units in the first service 230, respectively, the first service 230 may use the shared public key. Such exemplary embodiments will be described below with reference to FIG. 4. In some embodiments, the first key may be a public key for a certain processing unit of the first service 230. For example, in a scenario where the requester 210 is located outside the first service 230 and different requests sent by the requester 210 are all received by a certain processing unit in the first service 230, the first service 230 may use the public key for the above-mentioned certain processing unit. In some embodiments, the first key may be a symmetric key shared between different processing units of the first service 230. For example, in a scenario where the requester 210 is located inside the first service 230, the first service 230 may use the shared symmetric key.

Next, at 214, the first service 230 sends the attestation information and the first key to the requester 210. If the requester 210 determines, based on the attestation information, that the execution environment of the first service 230 is trusted and the first service 230 is an expected service, the requester 210 may determine that the first service 230 processes the data, that is, the requester 210 is going to send first data to the first service 230. The first data refers to data that the requester 210 expects the first service 230 to process. Exemplarily, the first service 230 may be a data query service, and the first data may be data to be queried that the requester 210 expects the first service 230 to process. To ensure data communication security, the requester 210 may generate a symmetric key and use the symmetric key to encrypt the first data to obtain the encrypted first data. To further improve the security of data communication, the requester 210 then uses the first key sent by the first service 230 to encrypt the symmetric key of the requester 210 to obtain an encrypted symmetric key. Further, the requester 210 generates a processing request based on the encrypted first data and the encrypted symmetric key.

After generating the processing request, at 215, the requester 210 sends the processing request to the first service 230. If the first service 230 receives the processing request from the requester 210, the first service 230 uses a second key related to the first key to decrypt the encrypted symmetric key in the processing request to obtain the decrypted symmetric key. Then, the first service 230 uses the decrypted symmetric key to decrypt the encrypted first data to obtain the decrypted first data. Next, the first service 230 processes the first data to obtain a processing result. Then, at 216, the first service 230 sends the processing result of the first data to the requester 210 in response to the processing request sent by the requester 210.

The embodiments of the present disclosure may implement selecting an appropriate key for secure communication in different scenarios that indicate different relationships between the requester and the service provider. For example, in a scenario where the requester 210 is located outside the first service 230 and different requests sent by the requester 210 are received by different processing units in the first service 230, respectively, a shared key between the multiple processing units inside the first service 230 may be used for data communication. For another example, in a scenario where the requester 210 is located outside the first service 230 and different requests sent by the requester 210 are all received by a certain processing unit in the first service 230, a key for the certain processing unit inside the first service 230 may be used for data communication. For yet another example, in a scenario where the requester 210 is located inside the first service 230, a symmetric key shared between multiple processing units inside the first service 230 may be used for data communication. Thus, with these improvements, the embodiments of the present disclosure not only expand the communication scenarios of the clustered services, but also improve the security and efficiency of data communication in each scenario. In this way, the embodiments of the present disclosure at least solve the problem of data communication security.

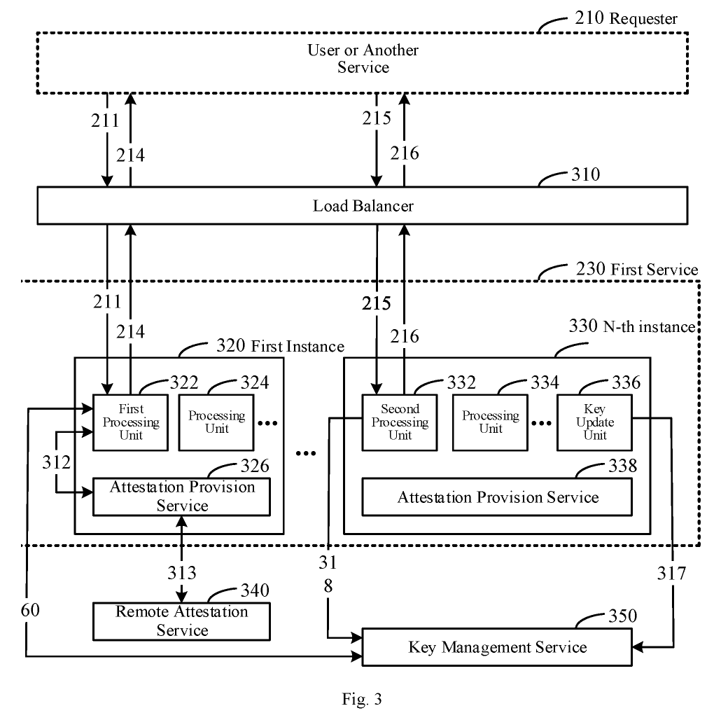

FIG. 3 shows a schematic diagram of an exemplary process of data communication in a scenario according to some embodiments of the present disclosure. The exemplary process of data communication may be applied to the following scenario: the requester 210 of data communication is located outside the first service 230, and the verification request and the processing request sent by the requester 210 may be received by different processing units inside the first service 230. The processing unit may refer to a smallest deployable and manageable unit for performing data processing inside the first service 230. The requests (for example, the verification request, the processing request, and the like) sent by the requester 210 may be randomly assigned to any processing unit inside the first service 230. In the scenario where the data communication process shown in FIG. 3 is applicable, the verification request and the processing request for the first service 230 sent by the requester 210 may be assigned to different processing units inside the first service 230.

For the scenario where the data communication process shown in FIG. 3 is applicable, when deploying the service in the cluster, the service deployer may use a key management service (KMS) to generate a shared key for the multiple processing units of the first service 230. In some embodiments, to improve the security of data communication, the TEE may be used to generate the KMS. The KMS may have key management capabilities such as key generation, key acquisition, and key update. In this case, the KMS may ensure the trustworthiness of the generated, acquired or updated key, thereby ensuring the security of the data communication process using the key.

The shared key generated by the KMS used by the service deployer may include a shared public key and a shared private key corresponding to the shared public key. The deployer may set the access permission for acquiring the shared key to be accessible only by the current service (for example, the first service) and the auxiliary service of the current service. The KMS may record the key identification corresponding to the generated shared key, and inform each processing unit in each instance inside the current service of information such as the key identification, the key update period, and the validity period of the attestation result by configuration. It would be appreciated that the instance may refer to a physical computing resource (for example, a physical machine) running independently in a clustered service, or a virtualized resource (for example, a virtual machine) running independently in a clustered service. An instance may include multiple processing units. Different instances may include the same or different processing units, such as different pods.

After the service deployer uses the KMS to inform each processing unit in each instance inside the service of the above information, any processing unit may use a certain mechanism to acquire the shared key corresponding to the key identification from the KMS after startup. Exemplarily, the processing unit may use a remote attestation (RA) mechanism to acquire the shared key corresponding to the key identification from the KMS after startup.

As shown in FIG. 3, when a user or another service located outside the first service 230, as the requester 210, expects to perform data communication with the first service 230, the requester 210 first sends the verification request to the first service 230 at 211. The verification request may be assigned by a load balancer 310 to the first processing unit 322 in the first instance 320 inside the first service 230. In some embodiments, the verification request may include a random number, also known as a challenge. As will be described below, the random number may subsequently be used to verify the attestation report from the first service.

It would be appreciated that the load balancer may evenly distribute the request traffic of the external public network to multiple service nodes of the cluster to which the load balancer belongs, so as to improve the processing capability of the cluster for external requests.

In some embodiments, after the load balancer 310 assigns the verification request to the first processing unit 322 in the first instance 320 inside the first service 230, the first processing unit 322 may access the EPS 326 in the first instance 320 to which the first processing unit 322 belongs to obtain the attestation report of the first processing unit 322 at 312. At 313, the EPS 326 may send the attestation report corresponding to the attestation report to the RAS 340 associated with the first service 230 to verify the validity of the attestation report.

It would be appreciated that, to ensure communication security, the first processing unit 322 may generate, after startup, a first public key for the first processing unit 322 and a first private key corresponding to the first public key. The first processing unit 322 may set the first public key as running data, which is reflected in the attestation report.

Continuing to refer to FIG. 3, if the RAS 340 determines that the attestation report is valid, it may generate an attestation result and return the attestation result to the EPS 326 in the first instance 320. At 360, if the first processing unit 322 obtains the attestation report and the attestation result, it may send the attestation information, key configuration information, and the first public key to the KMS 350. The attestation information may include at least one of the attestation report or the attestation result. The key configuration information may include at least the key identification. If the KMS 350 verifies that the attestation information is correct and the first processing unit 322 has the configured access permission, the KMS 350 sends the shared key encrypted with the first public key to the first processing unit 322. Further, if the first processing unit 322 receives the shared key encrypted with the first public key, the first processing unit 322 uses the first private key corresponding to the first public key to decrypt the encrypted shared key to obtain the decrypted shared public and private key pair (i.e., the shared public key and the shared private key corresponding to the shared public key) generated by the KMS for the multiple processing units of the first service. Exemplarily, the first processing unit 322 may set the shared public key as the running data in the attestation report.

In some embodiments, the multiple processing units in all the instances inside the first service 230 may reach a consensus on the shared public key and the shared private key corresponding to the shared public key by using a consensus algorithm or other means. In other words, the multiple processing units in all the instances inside the first service 230 may share a set of public and private keys in various ways. The method described in the embodiments of the present disclosure is only exemplary and not intended to be limitative.

Continuing to refer to FIG. 3, if the first processing unit 322 obtains the attestation information and decrypts to obtain the shared public key, the first processing unit 322 sends the attestation information and the shared public key to the load balancer 310 at 214. In some embodiments, the shared public key may be included in the attestation information. For example, if the attestation information includes the attestation report, the shared public key may be set as the running data in the attestation report. The load balancer 310 may forward the attestation information and the shared public key to the requester 210 after the test is passed. The requester 210 receives the attestation information and the shared public key sent by the first service 230. The requester 210 may determine, based on the attestation information, whether the execution environment of the first service 230 is trusted and whether the first service 230 is an expected service. If the requester 210 determines, based on the attestation information, that the execution environment of the first service 230 is trusted and the first service 230 is the expected service, the requester 210 generates a symmetric key. Further, the requester 210 uses the generated symmetric key to encrypt the first data to obtain the encrypted first data. The requester 210 uses the shared public key sent by the first service 230 to encrypt the generated symmetric key to obtain the encrypted symmetric key. At 215, the requester 210 generates the processing request based on the encrypted first data and the encrypted symmetric key. Then, the requester 210 sends the processing request to the load balancer 310. After passing the test on the processing request sent by the requester 210, the load balancer 310 may assign the processing request to the second processing unit 332 of the Nth instance 330 inside the first service 230. In some embodiments, the first processing unit 322 may be a first container set, and the second processing unit 332 may be a second container set. For example, the first processing unit 322 may be pod 1, and the second processing unit 332 may be pod 2.

In some other embodiments, after obtaining the attestation report, the EPS 326 inside the first instance 320 may not perform 313. In this case, the first processing unit 322 only sends the attestation report as the attestation information and the shared public key to the requester 210. The requester 210 may verify the validity of the attestation report in the attestation information by itself after receiving the attestation information. Specifically, if the requester 210 needs to verify the validity of the attestation report, the first processing unit 322 may use a hash algorithm to process the random number in the verification request and the shared public key to obtain hash data corresponding to the random number and the shared public key. The first processing unit 322 may include the hash data in the running data of the attestation report. Next, the first processing unit 322 sends the attestation report containing the hash data and the shared public key to the requester 210. After receiving the information sent by the first processing unit 322, the requester 210 first verifies the validity of the content in the received attestation report. After determining that the content in the received attestation report is valid, the requester 210 may verify the validity of the running data in the attestation report. Specifically, the requester 210 may use the hash algorithm to process the random number in the verification request and the shared public key received from the first processing unit 322 to obtain hash data to be verified. Next, the requester 210 verifies whether the hash data to be verified is consistent with the hash data in the attestation report sent by the first processing unit 322. If they are consistent, the requester 210 may determine that the running data is valid. If they are not consistent, the requester 210 may determine that the running data is invalid. In the case that both the content and the running data are valid, the requester 210 may determine that the attestation report sent by the first processing unit 322 is valid.

The second processing unit 332 may also acquire, from the KMS 350, the shared public key of the multiple processing units of the first service 230 and the shared private key corresponding to the shared public key in the same manner as the first processing unit 322. Accordingly, if the second processing unit 332 receives the processing request from the requester 210, the second processing unit 332 uses the shared private key to decrypt the encrypted symmetric key to obtain the decrypted symmetric key. Then, the second processing unit 332 uses the decrypted symmetric key to decrypt the encrypted first data to obtain the decrypted first data. Further, the second processing unit 332 processes the decrypted first data to obtain the processing result. At 216, the second processing unit 332 sends the processing result of the first data to the load balancer 310. The load balancer 310 may forward the processing result to the requester 210 after passing the test on the processing result of the first data, so as to implement that the first service 230 responds to the processing request of the requester 210.

It would be appreciated that the verification request sent by the requester 210 to the first service 230 may be received by any processing unit in any instance of the first service 230, and the processing request sent by the requester 210 to the first service 230 may be received by any other processing unit in the first service 230 other than the processing unit that receives the verification request. That is, the verification request and the processing request may be received by two different processing units inside the first service 230, respectively. The data communication process shown in FIG. 3 is only exemplary and not intended to be limitative, and the embodiments of the present disclosure are not limited in this regard.

In some embodiments, since the multiple processing units of all the instances inside the first service 230 share a set of public and private keys, when performing key update, in order to reduce the complexity of key update and improve the convenience of key update management, a key update unit may be deployed in any instance inside the first service 230. For example, the key update unit 336 may be deployed in the Nth instance 330 of the first service 230 shown in FIG. 3. As shown in 317, the key update unit 336 may initiate, to the KMS 350, an update request for the shared public key and the shared private key of the multiple processing units inside the first service 230 according to the key update period configured by the first service 230. After receiving the update request from the key update unit 336, the KMS 350 generates a new public key and a new private key corresponding to the new public key. The multiple processing units inside the first service 230 may periodically access the KMS 350 to ensure that the held shared public key and shared public key are up-to-date. After receiving the processing request from the requester 210, a processing unit may first try to use the new shared private key acquired at the last access to the KMS 350 to decrypt the encrypted symmetric key in the processing request. If the decryption fails, it may then try to use the old shared private key acquired at the previous access to the KMS 350 to decrypt the encrypted symmetric key in the processing request to implement the key update.

FIG. 4 shows a schematic diagram of an exemplary process of data communication in another scenario according to some embodiments of the present disclosure. The exemplary process of data communication may be applied to the following scenario: the requester 210 of data communication is located outside the first service 230, and the verification request and the processing request sent by the requester 210 are received by the same processing unit in an instance inside the first service 230. For the scenario where the data communication process shown in FIG. 4 is applicable, when deploying the service in the cluster, the service deployer may use the KMS described in the related embodiments of FIG. 3 to generate a key including a public key and a private key corresponding to the public key for the first processing unit of the first service 230, and may inform each processing unit in each instance inside the current service of information such as the key identification, the key update period, and the validity period of the attestation result of the key by configuration in the manner described in the related embodiments of FIG. 3. Similarly, any processing unit may use a certain mechanism to acquire the key corresponding to the key identification from the KMS after startup.

As shown in FIG. 4, when a user or another service located outside the first service 230, as the requester 210, expects to perform data communication with the first service 230, the requester 210 sends the verification request to the first service 230 at 211. In some embodiments, in the applicable scenario of FIG. 4, the verification request may include a random number, or a challenge. As will be described below, the random number may subsequently be used to verify the attestation report from the first service. Continuing to refer to FIG. 4, the verification request may be assigned to the first processing unit 322 in the first instance 320 inside the first service 230. At 312, the first processing unit 322 may access the EPS 326 in the first instance 320 to which the first processing unit 322 belongs to obtain the attestation report of the first processing unit 322. At 313, the EPS 326 may send the attestation report corresponding to the attestation report to the RAS 340 associated with the first service 230 to verify the validity of the attestation report. Accordingly, to ensure communication security, the first processing unit 322 may generate, after startup, a first public key for the first processing unit 322 and a first private key corresponding to the first public key. The first processing unit 322 may set the first public key as running data, which is reflected in the attestation report.

Continuing to refer to FIG. 4, if the RAS 340 determines that the attestation report is valid, it may generate an attestation result and return the attestation result to the EPS 326 in the first instance 320. At 214, if the first processing unit 322 obtains the attestation report and the attestation result, it may send the attestation information and the first public key to the requester 210. The attestation information may include at least one of the attestation report or the attestation result. After receiving the attestation information and the first public key sent by the first service, the requester 210 may determine, based on the attestation information, whether the execution environment of the first service 230 is trusted and whether the first service 230 is an expected service. If the requester 210 determines, based on the attestation information, that the execution environment of the first service 230 is trusted and the first service 230 is the expected service, the requester 210 generates a symmetric key. Next, the requester 210 uses the generated symmetric key to encrypt the first data to obtain the encrypted first data, and uses the first public key sent by the first service 230 to encrypt the generated symmetric key to obtain the encrypted symmetric key. At 215, the requester 210 sends the processing request generated based on the encrypted first data and the encrypted symmetric key to the first service 230.

In some other embodiments, after obtaining the attestation report, the EPS 326 inside the first instance 320 may send only the attestation report as the attestation information and the first public key to the requester 210 without performing 313. The requester 210 may verify the validity of the attestation report in the attestation information by itself after receiving the attestation information. In some embodiments, if the requester 210 needs to verify the validity of the attestation report, the first processing unit 322 may use a hash algorithm to process the random number in the verification request and the first public key to obtain hash data corresponding to the random number and the first public key. The first processing unit 322 may include the hash data in the running data of the attestation report. Next, the first processing unit 322 sends the attestation report containing the hash data and the first public key to the requester 210. After receiving the information sent by the first processing unit 322, the requester 210 first verifies the validity of the content in the received attestation report. After determining that the content in the attestation report is valid, the requester 210 may verify the validity of the running data in the attestation report. Specifically, the requester 210 uses the hash algorithm to process the random number in the verification request and the first public key received from the first processing unit 322 to obtain hash data to be verified. Next, the requester 210 verifies whether the hash data to be verified is consistent with the hash data in the attestation report sent by the first processing unit 322. If they are consistent, the requester 210 may determine that the running data is valid. If they are not consistent, the requester 210 may determine that the running data is invalid. In the case that both the content and the running data are valid, the requester 210 may determine that the attestation report sent by the first processing unit 322 is valid.

Still as shown in FIG. 4, if the processing request sent by the requester 210 to the first service 230 is received by the first processing unit 322 that receives the verification request, the first processing unit 322 uses the first private key corresponding to the first public key to decrypt the encrypted symmetric key in the processing request to obtain the decrypted symmetric key. Then, the first processing unit 322 uses the decrypted symmetric key to decrypt the encrypted first data to obtain the decrypted first data. Next, the first processing unit 322 processes the decrypted first data to obtain the processing result. At 216, the first processing unit 322 sends the processing result of the first data to the requester 210 in response to the processing request of the requester 210.

It would be appreciated that the verification request and the processing request sent by the requester 210 to the first service 230 may be received by any processing unit in any instance of the first service 230. The data communication process shown in FIG. 4 is only exemplary and not intended to be limitative, and the embodiments of the present disclosure are not limited in this regard.

In some embodiments, each processing unit inside the first service 230 may generate a new first public key and a new first private key corresponding to the new first public key according to the configured key update period to implement the key update. It would be appreciated that, after a processing unit inside the first service 230 completes key update, if the processing unit receives a new verification request from a new requester 210, the processing unit returns the new first private key to the new requester 210. In addition, in order to reduce resource occupancy, the processing unit deletes the first public key and the first private key before the update after the update of the first public key and the first private key has passed the validity period of the attestation result. It would also be appreciated that the key update period configured for the first service 230 is greater than the validity period of the attestation result.

FIG. 5 shows a schematic diagram of an exemplary process of data communication in yet another scenario according to some embodiments of the present disclosure. The exemplary process of data communication may be applied to the following scenario: the requester of data communication is any processing unit inside the first service 230, and the receiver of the processing request sent by the requester is any other processing unit inside the first service 230 that is different from the requester. For the scenario where the data communication process shown in FIG. 5 is applicable, when deploying the service in the cluster, the service deployer may use the KMS described in the related embodiments of FIG. 3 to generate a shared symmetric key for the multiple processing units of the first service 230. Moreover, the service deployer may inform each processing unit in each instance inside the current service of information such as the key identification and the key update period of the symmetric key by configuration in the manner described in the related embodiments of FIG. 3. Similarly, any processing unit may use a certain mechanism to acquire the shared symmetric key corresponding to the key identification from the KMS after startup.

As shown in FIG. 5, at 514, the processing unit 328 in the first instance 320 inside the first service 230 communicates with the second processing unit 332 in the N-th instance 330 using the symmetric key. The communication described herein may include communication for the verification request and communication for the processing request. Taking the processing request as an example, the processing unit 328 uses the shared symmetric key acquired from the KMS 350 to encrypt the first data to obtain the encrypted first data. Next, the processing unit 328 sends the encrypted first data as the processing request to the second processing unit 332. If the second processing unit 332 receives the processing request, the second processing unit 332 uses the shared symmetric key acquired from the KMS 350 to decrypt the encrypted first data to obtain the decrypted first data. Further, the second processing unit 332 processes the first data to obtain the processing result. The second processing unit 332 returns the processing result of the first data to the processing unit 328 in response to the processing request of the processing unit 328.

Still as shown in FIG. 5, the symmetric key shared by the multiple processing units of all the instances inside the first service 230 may be updated according to the key update manner described in the related embodiments of FIG. 3.

As may be seen from the above multiple embodiments, the embodiments of the present disclosure may at least implement selecting an appropriate key for secure communication in the following three scenarios: a scenario where it indicates that the requester 210 is located outside the first service 230 and different requests sent by the requester 210 are received by different processing units in the first service 230, respectively; a scenario where it indicates that the requester 210 is located outside the first service 230 and different requests sent by the requester 210 are all received by a certain processing unit in the first service 230; and a scenario where it indicates that the requester 210 is located inside the first service 230. Thus, the embodiments of the present disclosure not only expand the communication scenarios of the clustered service, but also improve the security and efficiency of data communication in each communication scenario of the clustered service. In this way, the embodiments of the present disclosure at least solve the problem of data communication security, and at least fulfill the user's expectation of secure and efficient data transmission with the computing cluster.

### Exemplary Process

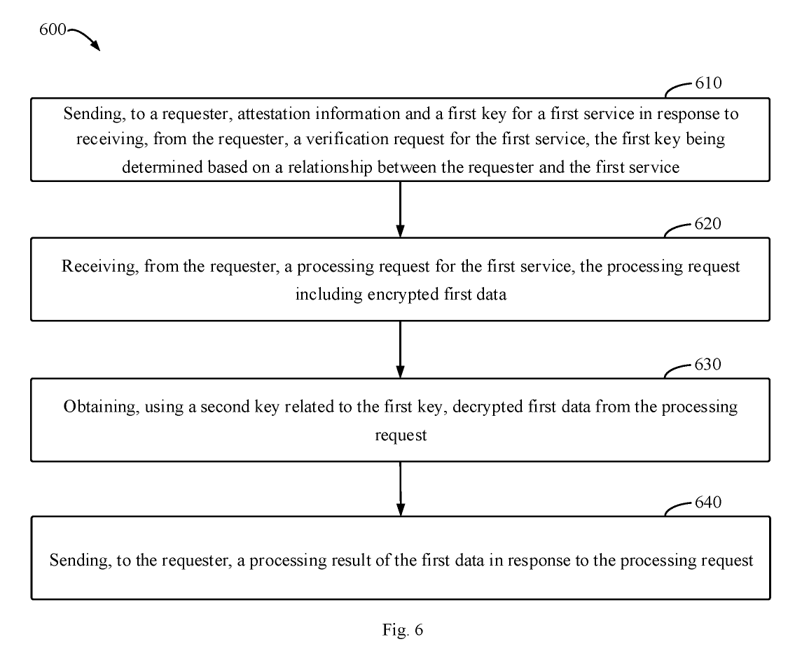

FIG. 6 shows a flowchart of a data communication process 600 applied to the first service 230 according to some embodiments of the present disclosure. The process 600 may be applied to the first service 230. The process 600 is described below with reference to FIG. 2.

At block 610, the first service 230 sends, to the requester 210, attestation information and a first key for the first service 230 in response to receiving, from the requester 210, a verification request for the first service 230, the first key being determined based on a relationship between the requester 210 and the first service 230.

At block 620, the first service 230 receives, from the requester 210, a processing request for the first service 230, the processing request including encrypted first data.

At block 630, the first service 230 obtains, using a second key related to the first key, decrypted first data from the processing request.

At block 640, the first service 230 sends, to the requester 210, a processing result of the first data in response to the processing request.

In some embodiments, the processing request further includes an encrypted symmetric key of the requester 210, and the first service 230 decrypts, using the second key, the encrypted symmetric key to obtain a symmetric key; and decrypts, using the symmetric key, the encrypted first data to obtain the first data.

In some embodiments, the requester 210 is located outside the first service 230, the verification request is received at a first processing unit of the first service 230, the processing request is received at a second processing unit of the first service 230, the first key includes a shared public key for multiple processing units of the first service 230, and the second key includes a shared private key corresponding to the shared public key.

In some embodiments, the first processing unit includes a first container set, and the second processing unit includes a second container set.

In some embodiments, the first service 230 generates, in response to the startup of the first processing unit, a first public key for the first processing unit and a first private key corresponding to the first public key; sends the attestation information, key configuration information of the first service, and the first public key to a key management service; and decrypts, using the first private key, an encrypted shared public key and an encrypted shared private key to obtain the shared public key and the shared private key in response to receiving the encrypted shared public key and the encrypted shared private key from the key management service.

In some embodiments, the requester 210 is located outside the first service 230, the verification request and the processing request are both received at the first processing unit of the first service 230, the first key includes the first public key for the first processing unit, and the second key includes the first private key corresponding to the first public key.

In some embodiments, the requester 210 is located inside the first service 230, and the first key and the second key include a symmetric key shared by multiple processing units of the first service.

In some embodiments, the verification request may be received at the first processing unit of the first service 230, and the first service 230 generates, in response to the startup of the first processing unit, the first public key for the first processing unit and the first private key corresponding to the first public key; sends the attestation information, the key configuration information of the first service 230, and the first public key to the key management service; and decrypts, using the first private key, an encrypted symmetric key to obtain a symmetric key in response to receiving the encrypted symmetric key from the key management service.

In some embodiments, the attestation information includes at least one of an attestation report or an attestation result, the attestation report indicates the trustworthiness of the execution environment of the first service 230, the attestation result includes a verification result of the attestation report, and the attestation information is obtained through an attestation provision service associated with the first service 230.

In some embodiments, the first service 230 sends, by a key update unit inside the first service, a key update request to the key management service based on a key update period configured by the first service; and receives, by the first processing unit, a key update response for the key update request from the key management service, the key update response including at least an updated first key and an updated second key.

In some embodiments, the first service 230 updates the first public key and the first private key based on a key update period configured by the first service, the key update period being greater than a validity period of an attestation result of the first service, the attestation result including a verification result of an attestation report of the first service, the attestation report indicating the trustworthiness of the execution environment of the first service; and deletes the first public key and the first private key before the update in response to the update of the first public key and the first private key passing the validity period of the attestation result.

In some embodiments, the requester 210 includes at least one of the following: a terminal device associated with a user, a second service different from the first service, or another processing unit in the first service that is different from the processing unit that receives the verification request.

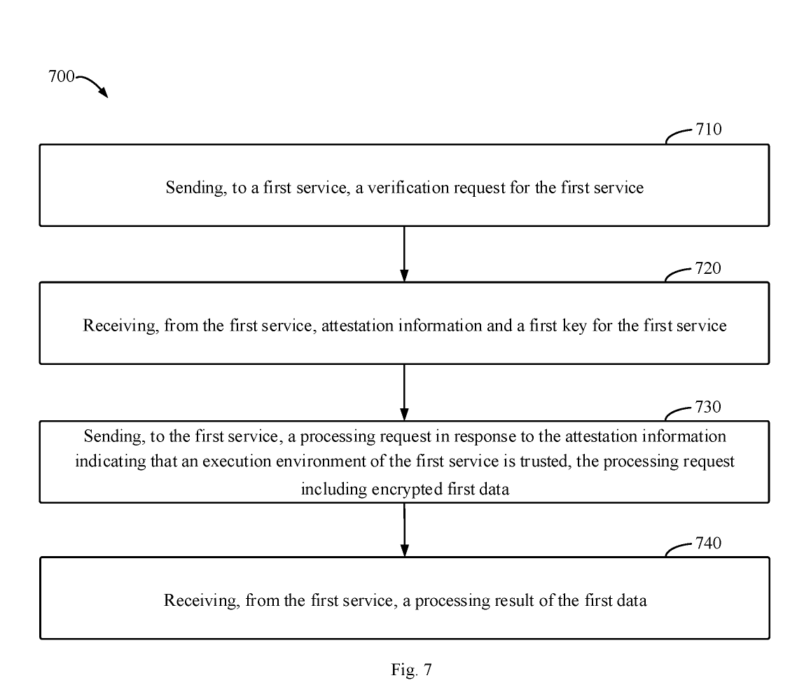

FIG. 7 shows a flowchart of a data communication process applied to a requester of data communication according to some embodiments of the present disclosure. The process 700 may be applied to the requester 210 of data communication. The process 700 is described below with reference to FIG. 2.

At block 710, the requester 210 sends, to the first service 230, a verification request for the first service 230.

At block 720, the requester 210 receives, from the first service 230, attestation information and a first key for the first service 230.

At block 730, the requester 210 sends, to the first service 230, a processing request in response to the attestation information indicating that an execution environment of the first service 230 is trusted, the processing request including encrypted first data.

At block 740, the requester 210 receives, from the first service 230, a processing result of the first data.

In some embodiments, the requester 210 generates the processing request by: encrypting the first data using a symmetric key of the requester 210 of the processing request to obtain the encrypted first data; encrypting the symmetric key using the first key to obtain an encrypted symmetric key; and generating the processing request based on the encrypted first data and the encrypted symmetric key.

In some embodiments, the requester 210 of the verification request and the processing request is located outside the first service, the verification request is received at a first processing unit of the first service 230, the processing request is received at a second processing unit of the first service 230, and the first key includes a shared public key for multiple processing units of the first service 230.

In some embodiments, the requester 210 of the verification request and the processing request is located outside the first service 230, the verification request and the processing request are both received at the first processing unit of the first service 230, and the first key includes a first public key for the first processing unit.

In some embodiments, the requester 210 of the verification request and the processing request is located outside the first service 230, and the first key includes a symmetric key shared by multiple processing units of the first service 230.

### Exemplary Apparatus and Device

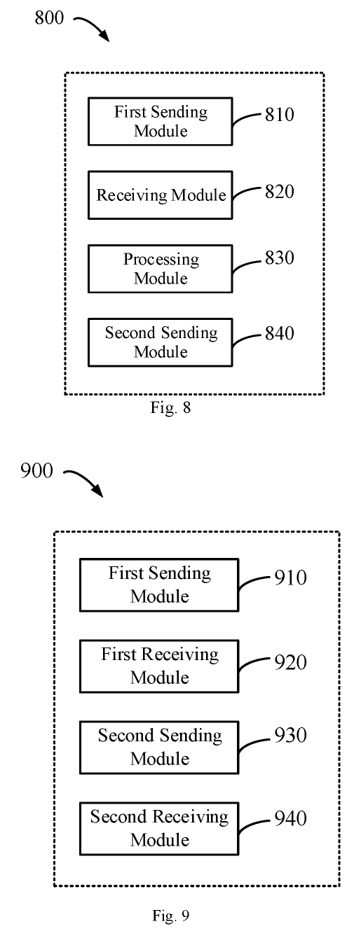

The embodiments of the present disclosure further provide a corresponding apparatus for implementing the above method or process. FIG. 8 shows a block diagram of an exemplary data communication apparatus 800 applied to a first service according to some embodiments of the present disclosure. Each module/component in the apparatus 800 may be implemented by hardware, software, firmware, or any combination thereof.

As shown in FIG. 8, the apparatus 800 includes: a first sending module 810 configured to, in response to receiving, from a requester, a verification request for the first service, send, to the requester, attestation information and a first key for the first service, the first key being determined based on a relationship between the requester and the first service; a receiving module 820 configured to receive, from the requester, a processing request for the first service, the processing request including encrypted first data; a processing module 830 configured to obtain, using a second key related to the first key, decrypted first data from the processing request; and a second sending module 840 configured to send, to the requester, a processing result of the first data in response to the processing request.

In some embodiments, the processing request further includes an encrypted symmetric key of the requester 210, and the processing module 830 is further configured to decrypt, using the second key, the encrypted symmetric key to obtain a symmetric key; and decrypt, using the symmetric key, the encrypted first data to obtain the first data.

In some embodiments, the requester 210 is located outside the first service 230, the verification request is received at a first processing unit of the first service 230, the processing request is received at a second processing unit of the first service 230, the first key includes a shared public key for multiple processing units of the first service 230, and the second key includes a shared private key corresponding to the shared public key.

In some embodiments, the first processing unit includes a first container set, and the second processing unit includes a second container set.

In some embodiments, the apparatus 800 further includes a first communication module configured to generate, in response to the startup of the first processing unit, a first public key for the first processing unit and a first private key corresponding to the first public key; send the attestation information, key configuration information of the first service, and the first public key to a key management service; and decrypt, using the first private key, an encrypted shared public key and shared private key to obtain the shared public key and the shared private key in response to receiving the encrypted shared public key and shared private key from the key management service.

In some embodiments, the requester 210 is located outside the first service 230, the verification request and the processing request are both received at the first processing unit of the first service 230, the first key includes the first public key for the first processing unit, and the second key includes the first private key corresponding to the first public key.

In some embodiments, the requester 210 is located inside the first service 230, and the first key and the second key include a symmetric key shared by multiple processing units of the first service.

In some embodiments, the verification request may be received at the first processing unit of the first service 230, and the apparatus 800 further includes a second communication module configured to generate, in response to the startup of the first processing unit, the first public key for the first processing unit and the first private key corresponding to the first public key; send the attestation information, the key configuration information of the first service 230, and the first public key to the key management service; and decrypt, using the first private key, an encrypted symmetric key to obtain a symmetric key in response to receiving the encrypted symmetric key from the key management service.

In some embodiments, the attestation information includes at least one of an attestation report or an attestation result, the attestation report indicates the trustworthiness of the execution environment of the first service 230, the attestation result includes a verification result of the attestation report, and the attestation information is obtained through an attestation provision service associated with the first service 230.

In some embodiments, the apparatus 800 further includes a first update module configured to send, by a key update unit inside the first service, a key update request to the key management service based on a key update period configured by the first service; and receive, by the first processing unit, a key update response for the key update request from the key management service, the key update response including at least an updated first key and an updated second key.

In some embodiments, the apparatus 800 further includes a second update module configured to update the first public key and the first private key based on a key update period configured by the first service, the key update period being greater than a validity period of an attestation result of the first service, the attestation result including a verification result of an attestation report of the first service, the attestation report indicating the trustworthiness of the execution environment of the first service; and delete the first public key and the first private key before the update in response to the update of the first public key and the first private key passing the validity period of the attestation result.

In some embodiments, the requester 210 includes at least one of the following: a terminal device associated with a user, a second service different from the first service, or another processing unit in the first service that is different from the processing unit that receives the verification request.

FIG. 9 shows a block diagram of an exemplary data communication apparatus 900 applied to a requester of data communication according to some embodiments of the present disclosure. Each module/component in the apparatus 900 may be implemented by hardware, software, firmware, or any combination thereof.

As shown in FIG. 9, the apparatus 900 includes: a first sending module 910 configured to send, to a first service, a verification request for the first service; a first receiving module 920 configured to receive, from the first service, attestation information and a first key for the first service; a second sending module 930 configured to, in response to the attestation information indicating that an execution environment of the first service is trusted, send, to the first service, a processing request including encrypted first data; and a second receiving module 940 configured to receive, from the first service, a processing result of the first data.

In some embodiments, the apparatus 900 further includes a generation module configured to encrypt the first data using a symmetric key of the requester 210 of the processing request to obtain the encrypted first data; encrypt the symmetric key using the first key to obtain an encrypted symmetric key; and generate the processing request based on the encrypted first data and the encrypted symmetric key.

In some embodiments, the requester 210 of the verification request and the processing request is located outside the first service, the verification request is received at a first processing unit of the first service 230, the processing request is received at a second processing unit of the first service 230, and the first key includes a shared public key for multiple processing units of the first service 230.

In some embodiments, the requester 210 of the verification request and the processing request is located outside the first service 230, the verification request and the processing request are both received at the first processing unit of the first service 230, and the first key includes a first public key for the first processing unit.

In some embodiments, the requester 210 of the verification request and the processing request is located outside the first service 230, and the first key includes a symmetric key shared by multiple processing units of the first service 230.

The units and/or modules included in the apparatus 800 and the apparatus 900 may be implemented in various ways, including software, hardware, firmware, or any combination thereof. In some embodiments, one or more units and/or modules may be implemented using software and/or firmware, for example machine-executable instructions stored on a storage medium. In addition to machine-executable instructions or as an alternative, some or all units and/or modules in the apparatus 800 and the apparatus 900 may be implemented at least partially by one or more hardware logic components. As an example, rather than a limitation, exemplary types of hardware logic components that may be used include field programmable gate array (FPGA), application specific integrated circuit (ASIC), application specific standard (ASSP), system on chip (SOC), complex programmable logic device (CPLD), and so on.

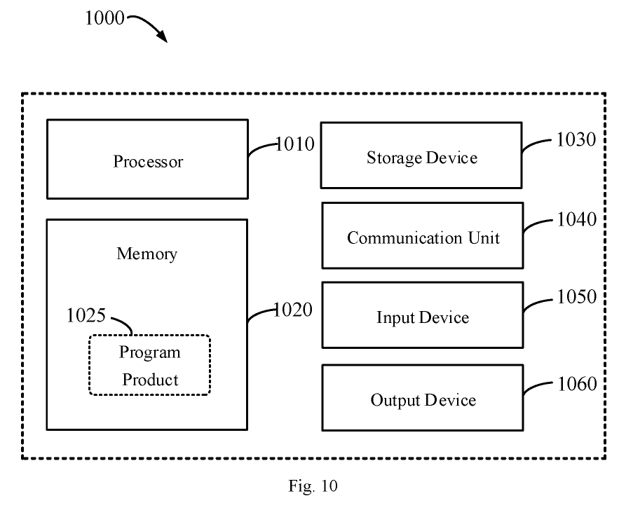

FIG. 10 shows a block diagram of an electronic device 1000 in which one or more embodiments of the present disclosure may be implemented. It would be appreciated that the electronic device 1000 shown in FIG. 10 is only exemplary and should not constitute any limitation to the function and scope of the embodiments described herein.

FIG. 10 shows a block diagram of an electronic device 1000 in which one or more embodiments of the present disclosure may be implemented. It would be appreciated that the electronic device 1000 shown in FIG. 10 is only exemplary and should not constitute any limitation to the function and scope of the embodiments described herein.

As shown in FIG. 10, the electronic device 1000 is in the form of a general electronic device. The components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and may execute various processes based on the programs stored in the memory 1020. In a multi-processor system, multiple processing units execute computer executable instructions in parallel to improve the parallel processing capability of the electronic device 1000.

The electronic device 1000 typically includes multiple computer storage medium. Such medium may be any available medium accessible by the electronic device 1000, including, but not limited to, volatile and non-volatile medium, removable and non-removable medium. The memory 1020 may be volatile memory (for example, a register, cache, a random-access memory (RAM)), a non-volatile memory (such as a read-only memory (ROM), an electrically erasable programmable read-only memory (EEPROM), a flash memory), or any combination thereof. The storage device 1030 may be any removable or non-removable medium, and may include a machine-readable medium such as a flash drive, a disk, or any other medium, which may be used to store information and/or data and may be accessed within the electronic device 1000.

The electronic device 1000 may further include additional removable/non-removable, volatile/non-volatile memory medium. Although not shown in FIG. 10, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 1020 may include a computer program product 1025, which has one or more program modules configured to perform various methods or acts of the various embodiments of the present disclosure.

The communication unit 1040 implements communication with other electronic devices through the communication medium. Additionally, the functions of the components of the electronic device 1000 may be implemented by a single computing cluster or multiple computing machines, which may communicate through communication connections. Therefore, the electronic device 1000 may use a logical connection with one or more other servers, a network personal computer (PC), or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may also communicate with one or more external devices (not shown) through the communication unit 1040 as needed, the external devices such as a storage device, a display device, etc., communicate with one or more devices that enable the user to interact with the electronic device 1000, or communicate with any devices (for example, a network card, a modem, etc.) that enable the electronic device 1000 to communicate with one or more other electronic devices. Such communication may be performed via input/output (I/O) interfaces (not shown).

According to an exemplary implementation of the present disclosure, there is provided a computer-readable storage medium having computer-executable instructions stored thereon, where the computer-executable instructions are executed by a processor to implement the method described above. According to an exemplary implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to the processing unit of a general-purpose computer, a dedicated computer, or other programmable data processing apparatus, thereby producing a machine, such that when these instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, these instructions cause the computer, the programmable data processing apparatus, and/or other devices to work in a specific way, and thus, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, so that a series of operations and steps are performed on the computer, the other programmable data processing apparatus or the other devices to produce a computer-implemented process, and thus, the instructions executed on the computer, the other programmable data processing apparatus, or the other devices implement the functions/actions specified in one or more blocks of the flowcharts and/or block diagrams.

The flowcharts and block diagrams in the drawings show the possibly implemented architectures, functions and operations of the system, method and computer program product according to multiple implementations of the present disclosure. In this regard, each block in the flowchart or block diagram may represent a module, a program segment or a part of instructions, and the module, the program segment or the part of instructions contains one or more executable instructions for implementing the specified logical functions. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It would also be noted that each block of the block diagrams and/or flowcharts, and a combination of blocks in the block diagrams and/or flowcharts may be implemented by a dedicated hardware-based system that executes specified functions or actions, or may be implemented by a combination of dedicated hardware and computer instructions.

The implementations of the present disclosure have been described above, and the above description is exemplary, non-exhaustive, and not limited to the disclosed implementations. Without departing from the scope and spirit of the described implementations, many modifications and changes would be apparent to those of ordinary skill in the art. The choice of terms used herein is intended to best explain the principles, practical applications or improvements of the technologies in the market of the implementations, or to enable other ordinary skilled in the art to understand the implementations disclosed herein.

1. A data communication method, comprising:
sending, to a requester, attestation information and a first key for a first service in response to receiving, from the requester, a verification request for the first service;
receiving, from the requester, a processing request for the first service, the processing request comprising encrypted first data;
obtaining, using a second key related to the first key, decrypted first data from the processing request; and
sending, to the requester, a processing result of the first data in response to the processing request.

2. The method according to claim 1, wherein the processing request further comprises an encrypted symmetric key of the requester, and obtaining the decrypted first data from the processing request comprises:
decrypting, using the second key, the encrypted symmetric key to obtain a symmetric key; and
decrypting, using the symmetric key, the encrypted first data to obtain the first data.

3. The method according to claim 1, wherein the requester is located outside the first service, the verification request is received at a first processing unit of the first service, the processing request is received at a second processing unit of the first service, the first key comprises a shared public key for multiple processing units of the first service, and the second key comprises a shared private key corresponding to the shared public key.

4. The method according to claim 3, wherein the first processing unit comprises a first container set, and the second processing unit comprises a second container set.

5. The method according to claim 3, further comprising:
generating, in response to a startup of the first processing unit, a first public key for the first processing unit and a first private key corresponding to the first public key;
sending the attestation information, key configuration information of the first service, and the first public key to a key management service; and
decrypting, using the first private key, an encrypted shared public key and an encrypted shared private key to obtain the shared public key and the shared private key in response to receiving the encrypted shared public key and the encrypted shared private key from the key management service.

6. The method according to claim 1, wherein the requester is located outside the first service, the verification request and the processing request are both received at a first processing unit of the first service, the first key comprises a first public key for the first processing unit, and the second key comprises a first private key corresponding to the first public key.

7. The method according to claim 1, wherein the requester is located inside the first service, and the first key and the second key comprise a symmetric key shared by multiple processing units of the first service.

8. The method according to claim 7, wherein the verification request is received at a first processing unit of the first service, and the method further comprises:
generating, in response to a startup of the first processing unit, a first public key for the first processing unit and a first private key corresponding to the first public key;
sending the attestation information, key configuration information of the first service, and the first public key to a key management service; and
decrypting, using the first private key, an encrypted symmetric key to obtain the symmetric key in response to receiving the encrypted symmetric key from the key management service.

9. The method according to claim 1, wherein the attestation information comprises at least one of an attestation report or an attestation result, the attestation report indicates a trustworthiness of an execution environment of the first service, the attestation result comprises a verification result of the attestation report, and the attestation information is obtained through an attestation provision service associated with the first service.

10. The method according to claim 1, further comprising:
sending, by a key update unit inside the first service, a key update request to a key management service based on a key update period configured by the first service; and
receiving, by a first processing unit, a key update response for the key update request from the key management service, the key update response comprising at least an updated first key and an updated second key.

11. The method according to claim 6, further comprising:
updating the first public key and the first private key based on a key update period configured by the first service, the key update period being greater than a validity period of an attestation result of the first service, the attestation result comprising a verification result of an attestation report of the first service, the attestation report indicating a trustworthiness of an execution environment of the first service; and
deleting the first public key and the first private key before the update in response to the update of the first public key and the first private key passing the validity period of the attestation result.

12. The method according to claim 1, wherein the requester comprises at least one of the following:
a terminal device associated with a user,
a second service different from the first service, or
another processing unit in the first service that is different from a processing unit that receives the verification request.

13. A data communication method, comprising:
sending, to a first service, a verification request for the first service;
receiving, from the first service, attestation information and a first key for the first service;
sending, to the first service, a processing request in response to the attestation information indicating that an execution environment of the first service is trusted, the processing request comprising encrypted first data; and
receiving, from the first service, a processing result of the first data.

14. The method according to claim 13, wherein the processing request is generated by:
encrypting the first data using a symmetric key of a requester of the processing request to obtain the encrypted first data;
encrypting the symmetric key using the first key to obtain an encrypted symmetric key; and
generating the processing request based on the encrypted first data and the encrypted symmetric key.

15. The method according to claim 13, wherein a requester of the verification request and the processing request is located outside the first service, the verification request is received at a first processing unit of the first service, the processing request is received at a second processing unit of the first service, and the first key comprises a shared public key for multiple processing units of the first service.

16. The method according to claim 13, wherein a requester of the verification request and the processing request is located outside the first service, the verification request and the processing request are both received at a first processing unit of the first service, and the first key comprises a first public key for the first processing unit.

17. The method according to claim 13, wherein a requester of the verification request and the processing request is located outside the first service, and the first key comprises a symmetric key shared by multiple processing units of the first service.

18. An electronic device, comprising: at least one processor; and at least one memory, wherein
the at least one memory is coupled to the at least one processor and stores instructions executable by the at least one processor, and
the instructions, when executed by the at least one processor, cause the electronic device to perform a data communication method, wherein
the data communication method comprises:
sending, to a requester, attestation information and a first key for a first service in response to receiving, from the requester, a verification request for the first service;
receiving, from the requester, a processing request for the first service, the processing request comprising encrypted first data;
obtaining, using a second key related to the first key, decrypted first data from the processing request; and
sending, to the requester, a processing result of the first data in response to the processing request; or
the data communication method comprises:
sending, to the first service, the verification request for the first service;
receiving, from the first service, the attestation information and the first key for the first service;
sending, to the first service, the processing request in response to the attestation information indicating that an execution environment of the first service is trusted, the processing request comprising the encrypted first data; and
receiving, from the first service, the processing result of the first data.
